(19) United States
(12) Patent Application Publication
(10) Pub. No.: US 2009/0223990 A1
(43) Pub. Date: Sep. 10, 2009

(54) SYSTEM FOR AUTHENTICATING PRESCRIPTIVE DRUGS AT THE TIME OF DISPENSING

(76) Inventors: Kenneth S. Bailey, Newport Beach, CA (US); Paul Mula, San Jose, CA (US)

Correspondence Address: Law Office of Scott C Harris Inc, PO Box 1389, Rancho Santa Fe, CA, 92067, US

(21) Appl. No.: 12/365,143

(22) Filed: Feb. 3, 2009

Related U.S. Application Data
(60) Provisional application No. 61/025,918, filed on Feb. 4, 2008.

(51) Int. Cl. B65D 83/04; G06F 17/00

(52) U.S. Cl. 221/2; 221/92; 700/231; 221/1; 901/30

(57) ABSTRACT

Prescription drugs are automatically determined and dispensed.

This application claims priority from provisional application No. 61/025,918, filed Feb. 4, 2008, the whole contents of the disclosure of which is herewith incorporated by reference.

### BACKGROUND

The recent emergence and proliferation of counterfeit prescriptive drugs throughout the world have caused healthcare professionals to pressure the United States Government to pass a measure that would control and regulate the counterfeit drug trade in America. Similarly, recently released studies have shown that inadvertently pharmacy employees have sold prescriptive drugs to patients which were mislabeled or not the prescribed dosages.

Counterfeit prescription drugs are illegal, generally unsafe, and often pose a serious threat to the public health. Many are visually indistinguishable from authentic drugs. As stated in the first Counterfeit Drug Task Force report in 2004 (2004 Report), it is believed that counterfeiting is quite rare within the U.S. drug distribution system because of the extensive scheme of federal and state regulatory oversight and the steps taken by drug manufacturers, distributors, and pharmacies, to prevent counterfeit drugs from entering the system. However, there are growing concerns that the U.S. drug supply is increasingly vulnerable to a variety of sophisticated threats. The FDA has witnessed an increase in counterfeiting activities and a more sophisticated ability to introduce finished dosage form counterfeits into legitimate drug distribution channels over the years.

The 2004 report called for a multi-layer approach to address the problem and included the following measures:

Secure the product and packaging

Secure the movement of drugs through the supply chain

Secure business transactions

Ensure appropriate regulatory oversight and enforcement

Increase penalties

Heighten vigilance and awareness

Increase International cooperation

In order to implement these measures, the Task Force Report stated, among other things, that:

Widespread use of electronic track and trace technology would help secure the integrity of the drug supply chain by providing an accurate drug “pedigree,” which is a record of the chain of custody of the product as it moves through the supply chain from manufacturer to pharmacy.

RFID is a promising technology as a means to achieve electronic pedigree (e-pedigree);

Widespread adoption and use of electronic track and trace technology would be feasible by 2007;

The effective date of certain regulations related to the implementation of the PDMA should be delayed until Dec. 1, 2006 in order to give stakeholders in the drug supply chain time to focus on implementing widespread use of e-pedigree.

In 2005, the Task Force issued an annual update report (2005 Report)⁴. The 2005 Report assessed FDA's and industry's progress toward implementing the 2004 recommendations. In the 2005 Report, the Task Force found, among other things, that:

Stakeholders had made significant progress in developing and implementing RFID during the previous year;

FDA was encouraged by the progress stakeholders, standard-setting bodies, and software and hardware companies had made toward implementing an e-pedigree for drug products and that they were optimistic that progress would continue in an expeditious manner toward meeting FDA's 2007 goal of widespread use of e-pedigree across the drug supply chain;

If it appeared that the 2007 goal would not be met, they planned to consider options for implementing the provisions of the PDMA rulemaking that are the subject of the stay; and

FDA would identify what they could do to address obstacles to the widespread adoption of RFID.

As the Task Force continued to monitor the adoption and implementation of e-pedigree and electronic track and trace technology, they recognized that adoption across the U.S. drug supply chain was slower than originally anticipated. To determine whether widespread use of e-pedigree by 2007 was still feasible, and to solicit comment on the implementation of certain PDMA-related regulations, they held a public meeting on Feb. 8 and 9, 2006. The objectives for the meeting were to:

Identify incentives for, as well as any obstacles to, the widespread adoption of RFID across the U.S. drug supply chain and possible solutions to those obstacles;

Solicit comment on the implementation of the pedigree requirements of the PDMA and the use of an e-pedigree; and

Learn the state of development of electronic track and trace and e-pedigree technology solutions.

Over 400 people attended the public meeting. Forty-six presentations were made and 27 vendors participated in the vendor display.

Members of the drug supply chain, the technology sector, special interest groups, academia, health professionals, and consumers also filed sixty comments to the public docket that we opened as part of the public workshop.

In addition, there have been conferences, meetings with stakeholders, tracking the status of pilot programs, monitoring changes in and use of technologies, participation in standards development, by task force members.

Their report was based primarily on information gathered from these fact-finding efforts. It contains views on outstanding issues related to e-pedigree and RFID implementation, as well as recommendations for additional public and private measures to support the continuing efforts to further secure the nation's drug supply.

The PDMA as modified by the Prescription Drug Amendments of 1992 (PDA) amended the Food, Drug, and Cosmetic Act (the Act) to, among other things, establish requirements related to the wholesale distribution of prescription drugs. Section 503(e)(1)(A) of the Act requires that

“. . . each person who is engaged in the wholesale distribution of a drug *** who is not the manufacturer or authorized distributor of record of such drug *** provide to the person who receives the drug a statement (in such form and containing such information as the Secretary may require) identifying each prior sale, purchase, or trade of such drug (including the date of the transaction and the names and addresses of all parties to the transaction.)”

PDMA defines an authorized distributor of record as a wholesaler that has an “ongoing relationship” with the manufacturer to distribute the drug. However it does not define “ongoing relationship.”

In December 1999, the Agency published final regulations (1999 final rule) (21 CFR part 203) related to the PDMA that were to take effect on Dec. 4, 2000. After publication of the final rule, the Agency received communications from industry, industry trade associations, and members of Congress objecting to the requirements in 21 CFR §§ 203.3(u) and 203.50. These provisions define the phrase “ongoing relationship” as used in the definition of “authorized distributor of record” (ADR), set forth requirements regarding an identifying statement (commonly referred to as a “pedigree”), and define the fields of information that must be included in the pedigree. Those objecting to the regulations explained that some secondary wholesalers may not receive pedigree information from their suppliers who meet the PDMA's definition of “authorized distributor” because the PDMA does not require authorized distributors to provide pedigree information. Without this information, they explained, secondary wholesalers would not be able to sell the drugs because they would be unable to pass a pedigree that met all the requirements of 203.50. Many secondary wholesalers are small businesses and expressed concern that their inability to meet the regulations' requirements would frustrate sales and drive them out of business.

Based on the concerns raised, the Agency delayed the effective date for those provisions until Oct. 1, 2001 in order to reopen the comment period for the regulations and receive additional comments. In addition, the House Committee on Appropriations (the Committee) requested that the Agency review the potential impact on the secondary wholesale pharmaceutical industry and prepare a report to the Committee summarizing the comments and issues raised and the Agency's plans to address these concerns. The Agency's report, which was submitted to Congress in June 2001 (2001 PDMA Report to Congress), concluded that we could address some of the concerns raised by the secondary wholesale industry through regulatory changes, but that some of the changes requested by the secondary wholesale industry would require statutory change. Since submitting the report to Congress, FDA has continued to delay the effective date of these provisions.

In February 2004 the FDA again delayed the effective date of the particular provisions until Dec. 1, 2006, because we were informed by stakeholders in the U.S. drug supply chain that industry would adopt electronic track and trace technology by 2007. When widely adopted, this technology could create a de facto e-pedigree that would document the movement of the drug from the place of manufacture through the U.S. drug supply chain to the final dispenser. If properly implemented, e-pedigree could meet the statutory requirements in section 503(e) of the Act.

In the 2006 fact-finding effort, the Task Force sought comment on whether to continue the delayed effective date, let the regulations go into effect, amend the 1999 final rule, or take other steps.

Most of the comments to the February 2006 notice advised FDA to implement the regulations and let the stay expire. Some said the regulations should be implemented as currently written, without amendment. Others suggested amending the final rule to either 1) exempt the passing of pedigree along primary supply chain routes or the “normal chain of distribution,” or 2) phase-in implementation, starting with requiring pedigrees for those drugs that are susceptible to counterfeiting and diversion, or 3) require a pedigree for “one forward-one back” in the distribution chain (as opposed to a pedigree that documents all prior sales transactions back to the manufacturer). A couple of comments suggested that they extend the stay in order to give industry more time to continue moving toward adoption of electronic track and trace technology and e-pedigree. A few wanted the stay to be extended in order to give time to amend the regulations. The amount of time requested for extending the stay varied from 5 years to indefinitely. They also received one citizen petition from a secondary wholesalers' trade association requesting that the stay be extended.

Some comments suggested that FDA work with Congress to eliminate the provision exempting the authorized distributor of record from having to pass a pedigree. They claimed that it was too confusing to recognize when a pedigree should or should not be passed.

Several comments asserted that implementation of the PDMA regulations would speed the development of new, less expensive ways to provide pedigree.

After carefully considering several options and recommend that the FDA no longer delay the effective date of §§203.3(u) and 203.50 past Dec. 1, 2006. Regulations defining “ongoing relationship” and “authorized distributor of record” are scheduled to go into effect thereafter. In the 2006 fact-finding efforts, they gave stakeholders and the public ample opportunity to provide their input, but did not hear the same arguments that were heard on previous occasions regarding why they should further extend the stay. Rather, this time, an overwhelming majority of the comments favored allowing the stay to expire.

The PDMA was signed into law in 1988. It is now believed that the FDA can no longer justify delaying implementation of these regulations. In its 2001 PDMA Report to Congress, FDA shared the concerns that were raised regarding implementation of the regulations. By recommending implementation of the stayed provisions, we are supporting the law that Congress passed and has since retained. Furthermore, our extensive experience with counterfeit and diversion drug cases reveals that the secondary wholesale market is where much of the illegal activity occurs. Allowing the stay to expire will provide clarity in the drug supply chain regarding who is and is not an ADR, requiring those secondary wholesalers who may be involved in illegal activity to provide pedigrees. Continuing the stay would perpetuate the current confusion and further allow opportunities for counterfeit and diversionary practices to flourish.

It is the intention of the Task Force not to put secondary wholesalers out of business. They therefore continue to be sensitive to the concerns that they raised several years ago, even though they did not hear these concerns during the current fact-finding effort. Therefore, as explained below, it was recommend that the FDA take an enforcement approach that focuses on products most susceptible to counterfeiting and diversion, which should relieve some of the burden that secondary wholesalers might confront when these regulations go into effect.

Most of the comments that were received in this fact-finding effort recommended that the regulations be implemented as is, while others advocated a phased-in approach, whereby the regulations would apply to a limited number of drugs at first. It is now agreed that the regulations should be implemented as is. Many of the recommended changes to the pedigree requirements would require a change in the law. The Task Force concluded that the regulations as currently written appropriately interpret and implement the PDMA, as Congress intended.

Although these regulations did not provide for a phased-in approach, they proposed that the FDA publish a Compliance Policy Guidance (CPG) before the stay expired that would contain a list of factors for FDA field personnel to consider in focusing their efforts when carrying out their duties in enforcing the law. It was proposed that these factors reflect a risk-based approach in which the FDA uses its limited resources to focus on drug products that are most vulnerable to counterfeiting and diversion. While they do not propose the creation of a list of drugs that meet the criteria, they instead suggest that the CPG provide examples. However, they also recommend that the FDA not limit its enforcement to just those drugs that meet the factors. Rather, the factors would merely provide guidance for where the field enforcement personnel should target their enforcement efforts. The factors to consider for the enforcement focus may include drugs with a high value in the U.S. market, drugs with prior indicators (such as drugs that were involved in diversion cases or counterfeiting), and drugs that are easily counterfeited.

Many States have moved forward with their own pedigree requirements, which often contain requirements in addition to those in the PDMA. Stakeholders are preparing to meet these State requirements, both electronic (to meet California law) or otherwise. Consequently, they should be that much closer to meeting the federal PDMA requirements as well.

In the Report, it was said that adoption and widespread use of reliable track and trace technology is feasible by 2007. It stated that this would help secure the integrity of the supply chain by providing an accurate drug “e-pedigree,” an electronic record documenting that the drug was manufactured and distributed under secure conditions. It particularly advocated for the implementation of electronic track and trace mechanisms and noted that RFID is the most promising technology to meet this need.

In the 2006 fact-finding effort, they sought comment on the progress of e-pedigree implementation in the drug supply chain to determine if the goals outlined in the 2004 Task Force Report would be met.

Since that time, several comments described completed and ongoing pilot programs for e-pedigree and their successful deployment of e-pedigree in a real-time production environment. Most pilot programs involved distribution with one manufacturer, one wholesaler, and, in some cases, one pharmacy. Many comments stated that e-pedigree can be achieved using either RFID or barcodes. A number of comments stated that standards for e-pedigree are complete and that interoperable software is available. A few comments from manufacturers of already-serialized products said that they have developed track and trace systems capable of providing an e-pedigree through existing internet technologies.

Most comments agreed that it was necessary to adopt mass serialization with unique identifiers on each package as an important step to facilitate e-pedigree, while some comments stated that it is not needed. A majority of the comments stated that although widespread use of e-pedigree is not far off, it is hard to predict when that might happen or set a new timetable or a new target date. However, many comments suggested that FDA set a specific date by which all products must have an e-pedigree, arguing that without a specific date progress toward adoption will continue to be slow. Some comments recommended that FDA establish realistic phased-in compliance dates for adoption of e-pedigree.

In 2004, there was considerable optimism that widespread implementation of e-pedigree was feasible by 2007 because it was stated by many stakeholders in the drug supply chain that this was a realistic goal. Although significant progress has been made to set the stage for widespread use of e-pedigree, unfortunately, this goal most likely will not be met. The Task Force decided it will not issue a new forecast or target date for adoption of e-pedigree since they do not have enough information to do so at the time. Most comments said that it is difficult to predict or designate a target date. It is still optimistically believed that a timetable with achievable, realistic milestones is crucial to keep e-pedigree implementation on track.

The Task Force still believes that members of the drug supply chain should be able to implement e-pedigrees in the very near future. There are several members who already are taking steps to implement an e-pedigree such as California. However, it is clear from recent fact-finding efforts that the voluntary approach that was advocated in the 2004 Task Force Report did not provide industry with enough incentives to meet FDA's deadline. The mere “risk” of the PDMA regulations being implemented was not enough of an incentive. When PDMA was enacted, the state of technology was not as advanced as it is today, and, as a practical matter the industry could pass only paper pedigrees, at that time.

In June of 2006, the Task Force stated as follow: “We understand the complexity in moving toward an e-pedigree and recognize that a hybrid approach using both paper and electronic pedigrees will be needed during a transition period. We continue to believe that RFID is the most promising technology for electronic track and trace across the drug supply chain. However, we recognize that the goals can also be achieved by using other technologies, such as 2D-barcodes. Based on what we have recently heard, we are optimistic that this hybrid environment of electronic/paper and the use of RFID/bar code is achievable in the very near future. We believe that efforts to ensure that hybrid pedigrees are secure and verifiable should be a priority consideration”.

“If legislation is considered in Congress related to e-pedigrees, we stand ready to provide technical assistance”.

Current progress on the use of RFID on drug product packages

A majority of the Task Force respondents agreed that RFID is the most promising technology for track and trace in the drug supply chain. They received many comments describing current obstacles to wider adoption of RFID, including:

A lack of standards (for e-pedigree fields and format, data systems, international transmission standards, and hardware specifications);

Privacy concerns;

Concerns about the ownership of confidential business transaction data;

Challenges in serializing all products;

Concerns over the accuracy and speed of electronic devices and systems; and

A lack of definitive data to determine how RFID will affect sensitive products (e.g., liquids, and biologicals).

Many comments stated that it is not possible to predict or estimate a timetable for widespread adoption of RFID, or stated that widespread RFID adoption is at least many years away. Some comments estimated that it will take up to 10 years. Many comments suggested that technical issues (e.g., adoption of standards, product/software development) would need to be settled before a more accurate timetable could be estimated. A number of comments suggested a phased-in approach for RFID adoption to provide industry sufficient time to explore all options. One comment from a stakeholder closely involved in the development of RFID technology stated that the FDA timeline for RFID adoption is technically feasible, that is, widespread adoption of RFID is feasible by 2007.

Comments noted that progress toward the full adoption of RFID technology is occurring, but that adoption is moving more slowly than previously anticipated. Several pilot projects have been conducted or are underway to test the feasibility of RFID deployment along the prescription drug supply chain, but data is limited.

Most comments said that the FDA should not mandate or require the use of RFID in the drug supply chain. Instead, some comments said that the FDA should continue to encourage the use of RFID. Many comments said that the FDA should actively participate in, support, and facilitate RFID activities, especially those activities of groups working to establish RFID standards and implementation. In addition, many comments said that the FDA should take a lead role in developing a public education program about the use of RFID technology on drug products.

Most comments said that incentives would help in the adoption of RFID across the supply chain. Only one comment said that no incentives are needed. Comments suggested the following incentives:

Financial/tax incentives;

Mandating mass serialization on drug products, but allowing industry to determine the most appropriate technology to ensure compliance;

Statutory changes.

The Task Force report of June 2006 also states, “Although we are encouraged by the efforts of GlaxoSmithKline, Pfizer, and Purdue-Pharma in tagging their products, and the efforts of many other companies and wholesalers in exploring and piloting RFID, we are disappointed with the lack of overall progress across the drug supply chain. In the 2004 Task Force Report, we laid out milestones and goals for RFID implementation based on credible information that stakeholders gave us. Many of these milestones have not been met. The technology vendors uniformly told us that their RFID and e-pedigree solutions and technologies are ready to go, but manufacturers, wholesalers, and retailers are slow to implement them”.

“We recognize that progress may have been delayed because standards have not yet been established. However, we are encouraged by the progress that industry has made to develop and adopt universal standards. Based on what we heard, those standards are close to completion. Once completed, we would expect to see a rapid growth in the implementation of RFID in the drug supply chain. We look forward to continuing to participate and support this standards development process”.

“While we recognize that implementing an RFID-enabled drug supply chain is challenging. We appreciate the comments advocating a phased-in approach and urge manufacturers to take a risk-based approach to implementation by first tagging the products that are most vulnerable to counterfeiting and diversion, based on factors such as the sales price, volume sold, demand, ease of counterfeiting, and prior history of counterfeiting or diversion, among other things. If a company's products are not “at risk”, then we would suggest the company choose its highest volume/highest sale drug(s) and start piloting. Although RFID deployment does have significant start up costs, based on our discussions and what we heard, most stakeholders agree that there are also significant benefits. Not only does the track and trace capability of RFID provide anti-counterfeiting and supply chain security benefits, but it also offers significant savings in the form of better inventory management, reduction in theft and product loss, improved recall efficiency, and reduced paperwork burdens”.

Almost all the comments recommended that industry use a single numbering convention to reduce costs and complexity. One comment noted that multiple numbering schemes could lead to conflicts (e.g., duplicate numbers for the same item) and incompatibility between points in the distribution chain. Several comments suggested that using random numbers for the product identification component of the electronic product code (EPC) could increase security, while concealing proprietary information about the product or manufacturer. However, other comments suggested that the EPC should include the manufacturer ID as part of the code.

Many comments addressed whether or not the NDC should be included in the unique identifier. Many comments were concerned that RFID tags could be surreptitiously read, and if the NDC was included, it could jeopardize the privacy of patients and potentially endanger the drug supply chain. However, pharmacies and their trade groups supported the inclusion of the NDC, arguing that their information systems currently identify products by using the NDC and that they might incur significant costs to change these systems if they used an EPC that did not include the NDC. Some of these comments also noted that the NDC plays an important role in the dispensing process and it would be disruptive to workflow to have to consult another database to link the EPC number to the NDC number. However, a couple of the comments noted that it is not necessary to include the NDC as a component of the unique identifier because, pursuant to FDA regulations (21 CFR §§ 201.2 or 201.25), the NDC is printed on most drug packaging.

Finally, several comments from stakeholders that are closely involved in developing the EPC standards suggested that the numbering convention be sufficiently flexible to accommodate standards-based numbering systems already in use (e.g. NDC for pharmaceuticals, UID for U.S. Department of Defense, EAN.UCC for consumer goods.)

Ideally, there should be one numbering scheme used in the drug supply chain. It is recognized that the technology continues to advance and it is difficult to predict what its capabilities will be in the near future.

The stakeholder suggested data fields that could be captured in a uniform pedigree, including:

Product Information: drug name, manufacturer, product NDC, dosage form, strength, container size;

Item Information: lot number and expiration date, quantity of units by lot, product serial number (if serialized);

Transaction Information: transaction identifier (e.g., PO, invoice) and date, transaction type (e.g., sale, transfer, return), date received;

Trading Partner Information: business name, address and license of seller, alternate ship-from location of seller, seller contact information for authentication, business name, address and license of recipient, alternate ship-to location of recipient;

Signatures/Certifications: digital signature of seller, digital signature of recipient.

There was near complete agreement that all wholesalers, not just non-authorized distributors, should be responsible for passing pedigree information. Many of these comments urged FDA to take appropriate steps to require a universal and nationally uniform e-pedigree so that stakeholders do not have to comply with 50 different State pedigree requirements.

For e-pedigree transmission to be successful throughout the drug supply chain, business partners at each point in the supply chain should be able to share information effectively and efficiently. The choice of data management practices and standards becomes an important one for all stakeholders. One issue that has been raised is whether the data/information should be stored in one central database or if a distributed approach (where each stakeholder's system exchanges information with other systems) should be used.

A majority of the comments advocated the use of a distributed database approach to data management. Many noted that a centralized database would be more costly, slower to implement, a threat to patient privacy, and could disrupt drug distribution if the database was unavailable or compromised for some reason. Comments suggested that secure peer-to-peer transactions would be possible under the distributed model. One comment suggested that data management be controlled centrally via a third party, contractually-managed by FDA.

A few comments suggested specific data security measures, such as pedigree documents having digital signatures to maximize document integrity, authentication, and non-repudiation. Some comments referred to existing data transmission standards used elsewhere, specifically Public Key Infrastructure, Federal Information Processing Standards, and the ISO/ICE standards 17799 or 12207. One comment noted that e-pedigrees could be authenticated electronically, using electronic verification of the digital signature and the signed transaction content for each transaction. One comment promoted the use of biometric log-on methods to improve security.

It is generally believed that it is essential that every entity in a drug product's chain of custody has access to the product's pedigree data all the way back to the manufacturer, in order to verify and authenticate the pedigree. It is also important for FDA to have access to the information in matters of suspect illegal activity.

There is general concern that an unauthorized person might be able to read the information from an RFID tag on a drug without the possessor of the drug knowing it, possibly disclosing personally identifiable information or the name of the drug.

The majority of the comments indicated that privacy safeguards are needed. However, some pharmaceutical organizations said that patient privacy issues are not a major concern because many of the prescriptions filled at pharmacies are not dispensed in the original bottles from the manufacturer; the prescriptions are instead placed in a consumer-size container, which would not have an RFID tag. Some comments cited concern about persons gaining unauthorized access to information about the type of drug being taken as well as personal identifying information. Several comments said that the RFID tag should not contain information that identifies the drug (e.g., NDC number). Instead, these comments suggested that the tag should contain a random serialized number so that anyone reading the tag would see only a meaningless number.

Many comments referred to the importance of consumer notice and choice and the use of fair information practices. Comments noted that notice of the presence of an RFID tag on a drug package should be clear, conspicuous, and accurate. Several comments indicated that one way to address the issue of consumer notice is to use a symbol on the package. There was uncertainty, however, as to where the symbol should be placed.

Some comments pointed out that many concerns about privacy are due to concerns about database security (i.e., once the data is collected from an RFID tag, how secure is the database where it is stored?).

The majority of comments said that consumer education is needed for the successful adoption of RFID across the drug supply chain. Many comments indicated that consumers should be informed of the benefits of RFID (e.g., how RFID can help secure the drug supply chain), as well as the risks associated with the technology (e.g., potential threat to privacy). According to some comments, consumers should also be educated about the options that are available for deactivating or removing the RFID tag. Most comments said that FDA, as well as experts in academia, industry, and patient and consumer groups, should be involved in developing education programs.

Privacy issues are a real concern for consumers and FDA. These concerns will continue unless there is appropriate disclosure of the presence of an RFID tag on containers given to patients and sufficient education about the application, true risks, benefits, and vulnerabilities associated with RFID tags on drug products. This is no easy task.

Although the idea of labeling is generally supported, the use of a statement or symbol to disclose the presence of an RFID tag on a drug product package, may become necessary, it is important that manufacturers work with FDA to develop an appropriate message or symbol. Most statements made on the labeling of prescription drug products are regulated by FDA and subject to agency pre-approval. It has been therefore recommend that manufacturers should work with FDA before choosing a statement or symbol to add to their product labeling.

The Task Force has also been willing to work with stakeholders to develop a uniform statement or symbol that can be used to signal the presence of an RFID tag on a drug product package to use in educational campaigns. Such campaigns would help consumers to readily identify and understand the meaning of the statement or symbol.

Some people have suggested that the RFID tag should be “turned off” or deactivated before it leaves the pharmacy, or that patients should be given the choice of whether it is “turned off”. Many comments indicated that deactivating or removing the RFID tag at the point of purchase (i.e., the pharmacy) would effectively address privacy concerns. However, some comments pointed out that while deactivating or removing the tag would address privacy concerns, it may also prevent post-sale benefits (e.g., recalls) which would have been possible had the tag remained active/in place.

Some pharmacy groups said that the tag should be deactivated prior to arrival at the pharmacy retailer to ensure that no patient is inadvertently sent home with an active tag. One comment said that in practice, deactivating the tag at the point of sale is not feasible because it would place too much responsibility on pharmacists and may re-expose the drug to unknown radio-frequency effects. Some comments indicated that FDA should provide guidelines to ensure privacy protections through RFID tag deactivation or removal.

Many comments suggested various deactivation methods. Some of the suggested options were: kill function (total or partial), blocker chips, encryption, read protection, decommissioning with individual tag password, tag destruction, placing RFID tagged objects in a foil lined bag (which would prevent unwanted reads), and database controls. There was no consensus on the best deactivation method. However, a standards organization commented that it is evaluating tag deactivation, taking into consideration the consumer and industry benefits of post-sale uses of RFID tags. The point in the supply chain where RFID tags should/could be deactivated is also being evaluated.

There are benefits to both keeping the RFID tag active after sale and deactivating it before dispensing the product. The Task Force believes that an active tag can provide valuable information if the drug product finds its way back into the drug supply chain. The FDA has found counterfeit and diverted drugs in the drug distribution system when drug wholesalers, third-party return entities, or manufacturers return drugs for credit and/or destruction. It is believed that products with active tags would be easier to identify and track through the supply chain. That said, while respecting various privacy concerns, the Task Force does not believe that it is necessary for an active tag to go to the patient.

It is unclear whether technological methods to deactivate the tag in the normal course of business are mature enough for use in the marketplace at this time. The Task Force believes that this issue warrants further discussion among stakeholders, technology experts, and consumers, about the viable options and have refrained from making any specific recommendations up to this time.

It has therefore been determined and concluded that the FDA's vision of a safe and secure drug supply chain is premised on transparency and accountability by all persons who handle the prescription drug, starting with the manufacturer and ending with the pharmacist who hands the drug over to the patient. Drug supply chain efforts that capitalize on advances in electronic track and trace technology to create a secure electronic pedigree further this vision.

Since the implementation of the PDMA regulations in December 2006, it was expected that supply chain stakeholders would move quickly to adopt electronic track and trace technology, implementing RFID in a phased-in approach, however in reality, this has been slow in coming to fruition. While it has been recognized that there are important issues that still need resolution, such as privacy concerns and uniform and universal pedigrees that might benefit from further discussion by stakeholders or Congress, the primary issue is technology and an efficient manner in order to implement and deploy such technology as adequately suits this need. In the meantime, Companies still continue to tag drug products, build infrastructure across the supply chain for using an e-pedigree, and remain vigilant in their responsibility to provide a safe and effective drug product to the patient, without the necessary technology tools to do so.

### SUMMARY

The Foregoing detailed historical background on the Task Force's studies and the FDA and Federal Regulatory intiatives makes it more and more important to find an industry standardization on which every stakeholder can agree.

The present application addresses many of the These concerns by the healthcare industry have prompted the current invention to address these problems.

An embodiment uses a visual detection and verification system that visually inspects and authenticates drugs at an instant of dispensing, packaging or distribution.

One embodiment uses ** an optical scanner, an automated bottle dispensing arm, a barcode reader and a weighing device, coupled to a system computer which contains stored database(s) regarding the molecular composition, weight, dosage, and manufacturer or product origin information, regarding the drugs being dispensed, packaged or distributed.

### BRIEF DESCRIPTION OF THE DRAWINGS

FIG. 1 depicts the robotic portion of the preferred embodiment and shows how the prescription is filled after all necessary verifications have been met.

FIG. 2 depicts the method in which the drug or compound is verified on a molecular level for accuracy of dosage, authenticity of compound and meets specified prescription as written.

FIG. 3 depicts the scanner and method for verifying the prescription for accuracy and authenticity.

FIG. 4 depicts the end to end system components and their relationship to one another in the system; and

FIG. 5 depicts the system flow chart that indicates the system operating parameters and contingencies during normal operations.

### DETAILED DESCRIPTION

An embodiment addresses some or all of the concerns noted above—including privacy, standardization, accountability, traceability, and authentication.

An embodiment describe combining of divergent technologies to create an easy to deploy and fool-proof system that satisfies the core issues immediately without the necessity to be concerned with public privacy issues at all.

The several parts of the system may include:

The Storage Bin or Container that holds the pills/containers

An optical sensor which determines if the contents of the container are as printed on the outside label or container bar code tag.

A weighing device which determines how many tablets or pills are contained in the storage bin or container at all times.

A robotic arm which fills the patient's order with the correct pills or tablets, once the patient's script has been entered electronically by scanner.

A Scanner which scans the prescription, scans the wireless name badge or tag of the employee who is doing the dispensing, or accepts employee fingerprint, scans the bar coded label or tag for accuracy, and activates the robotic arm to fill and dispense the prescribed amount of the correct dosage of the verified authentic compound or pill.

The above described system assures that the proper person receives the proper dosage, in a properly labeled container, after having verified the drug on a molecular level to determine both the genuineness of the drug(s) (to avoid placebos or counterfeits), and that the drug has not been confused in dosage or type with a similar sounding or similar looking drug(s).

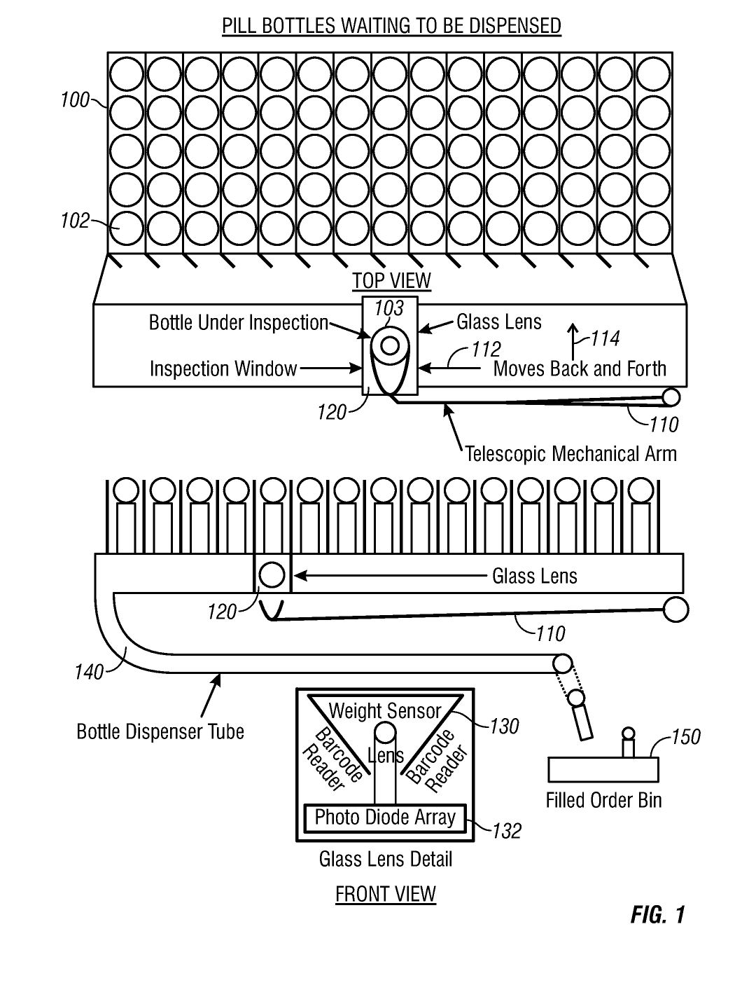

FIG. 1 illustrates the embodiment where there is a rack for example 100 of pill bottles to be dispensed. FIG. 1 shows the rack from the top view, showing a number of individual pill bottles such as 102. Each pill bottle such as 102 may have a specific content, and the different pill bottles may be arranged in an array where different pill bottles represent different items. For example, bottle 102 which is in position in the array 101, which may be stored in a controlling computer.

A telescopic mechanical arm 110 moves between the different positions on the holder 101, and selects one or more of the bottles at any time. For example, the telescopic arm may telescope in the direction 112, and may also move in the direction 114. This arm allows removing the bottles and moving them to. In FIG. 1A, the arm I could just stay FIG. 1 the arm has received one bottle 103. This bottle is placed on an inspection window 120, formed for example of a glass lens.

The bottom portion of FIG. 1 shows more detail on the glass lens and the structure. The glass lens may be part of a weight sensor assembly 130 that may include the lens, and may also include a bar-code or other optical reader. The bar-code reader can be formed for example of a photo diode array that reads the contents of a marking that is placed at the bottom of the bottle. In one embodiment, the marking may be a two-dimensional bar-code that represents the contents of the bottle. Another embodiment may use an encoded hologram to represent bottle contents.

After the bottle has been properly verified as being the correct medicine, it can be removed by the mechanical arm 110, and placed into a delivery tube 140. The delivery tube then sends the bottles to a filled order bin 150.

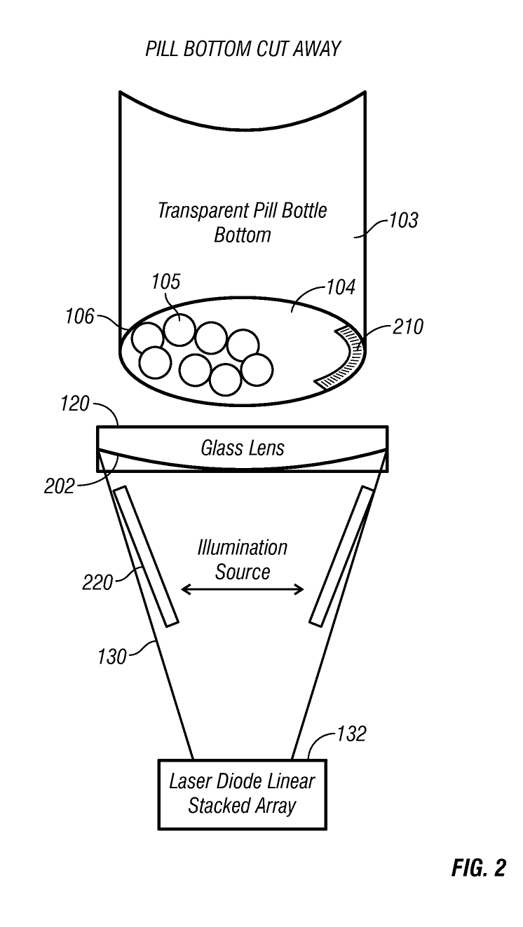

FIG. 2 illustrates more detail of the sensor and bottle device. The inspection window 120 is shown to have a glass lens 202 that focuses on the contents of the bottle 103 that is placed on the inspection window 120. In the embodiment, the bottle 103 may have a transparent bottom shown as 104, and different pills such as 105, 106 can be seen through the transparent bottom. In this embodiment, there can also be a bar-code such as 210 printed on a peripherla portion of the pill bottom. The reader assembly 130 may include an illumination source 220, directed in a substantially conical direction through the glass lens to illuminate the pill bottle bottom. In addition, the photo diode array 132 is shown which images the pill bottle bottom.

In one embodiment, the markings or other recognizable characteristics of the pills can be read through the transparent pill bottom.

In another embodiment, the bottles are intended to be filled to only a single layer, so that the pills can be individually counted through the bottom of the bottle.

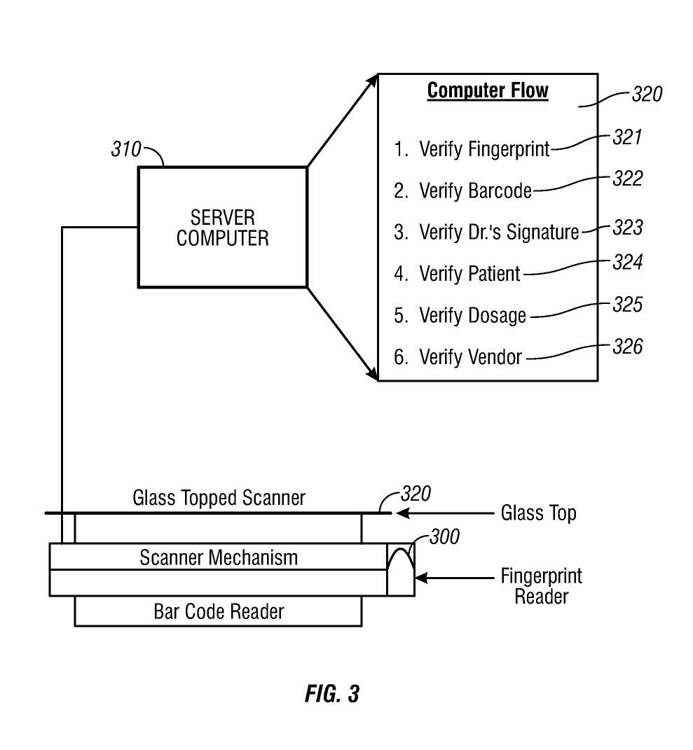

FIG. 3 shows how another scanning assembly 320. In one embodiment, the scanner may also include a fingerprint reader such as 300. The scanning assembly 320 reads the prescription, and may also reads the fingerprint, e.g., of an employee, from the fingerprint reader 300.

All of the information is sent to a server computer 310. The server computer 310 may carry out the verification flow shown as 320 including:

Verifying the fingerprint at 321, to ensure that the fingerprint is actually an authorized person who is authorized to dispense drugs.

At 322, the bar-code can be verified to ensure that it is a proper verification of the drugs.

The doctor signature can be verified at 323.

At 324 the patient is verified.

At 325 the dosage is verified. At 326, the vendor is verified.

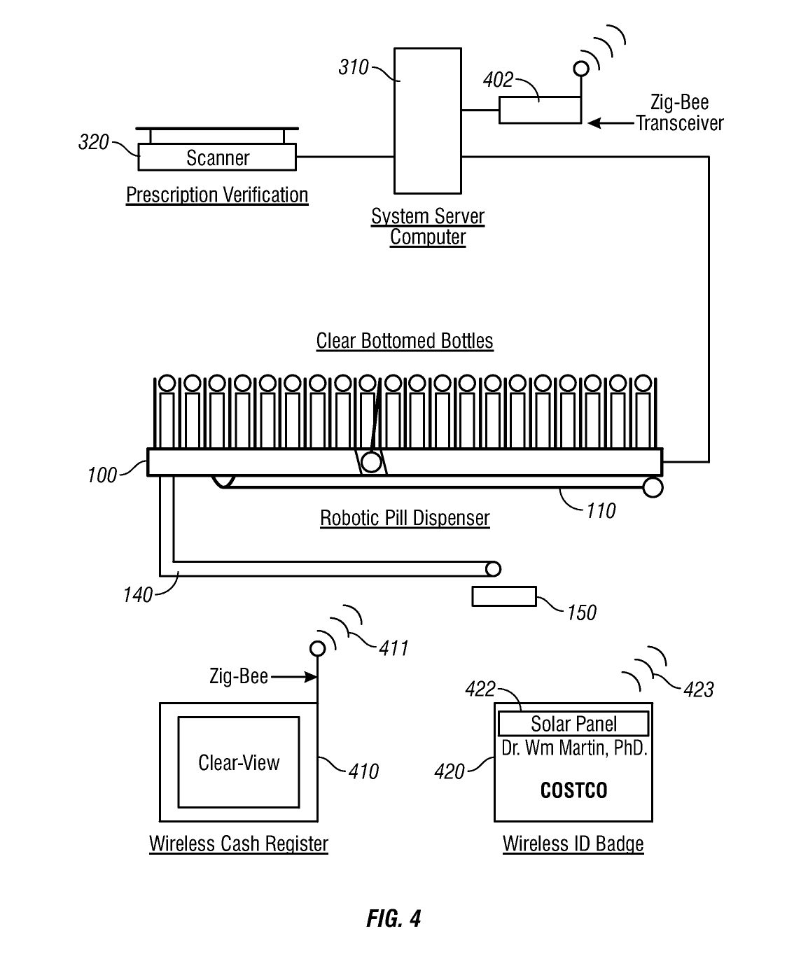

According to another embodiment, the information received from the drugs can be correlated with payment information. In the embodiment of FIG. 4, the pill dispenser assembly shown generally as 100 has the robotic arm 110 as in FIG. 1, and has dispenser system 140 with the order bin 150. The robot arm and other structure may be controlled by the server computer 310.

This embodiment also has a prescription verification scanner using a wireless network embodiment. According to this wireless network embodiment, the server 310 includes a wireless transmitter 402 which receives information from other wireless structures. The pill dispenser may also be wireless, although the embodiments shown in FIG. 4 shows a wired connection. In this embodiment, a wireless cash register 410 is used along with a wireless ID badge 420. Both the cash register and the ID badge produce wireless signals indicative of the operation. The ID badge controls determining which person is carrying out prescription fulfillment at a specific time. The wireless cash register keeps track of transactions, such as what signals are being sent and received at specified times. For example, the wireless cash register may record the date and time of each transaction. At the same time, the wireless ID badge 420 may record the times when the employee is located in certain places. The wireless ID badge may use of solar panel 422 to power circuitry inside the wireless ID badge. Both the wireless cash register 410 in the wireless ID badge sends the information wirelessly. For example, the wireless cash register sends a wireless signal 411. This signal may be sent using a Zigbee format. The wireless ID badge also sends a wireless signal for example 423. This is received by the corresponding transceiver in the system server computer which can correlate the location of the employee from the badge 420, the register transactions from register 410, and information from the prescription.

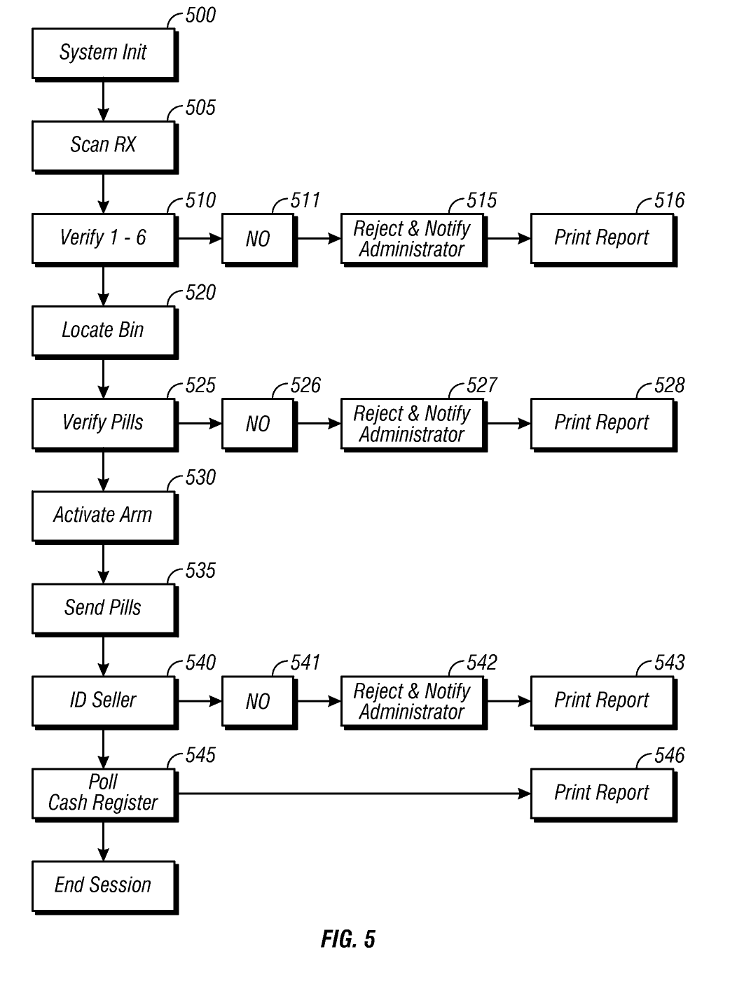

The operation is shown in FIG. 5. After system initialization at 500, a prescription is scanned at 505. The prescription may be scanned, for example, using the prescription verification scanner 320. At 510, the system verifies the parameters 1-6 described with reference to FIG. 3. If any of those are incorrect, then the operation is rejected at 515 and the administrator is notified. A report of a rejected prescription is printed of 516. If each of 1-6 are verified, than 520 locates a bin within the array of bins that is holding the prescription.

The system verifies the pills at 525, for example using the optical system. If the pills are not verified at 526, a rejection is carried out at 527 and the administrator is notified, followed by a report being generated at 528.

If the pills are verified at 525, then the robotic arm is activated at 532 to pick up the pills, and send them at 535. 540 comprises identifying the seller, which if rejected at 541 is again notified to the administrator and a report printed at 543.

At 545, the cash register is polled to be sure that the user actually paid for those pills, and a report is generated at 546.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other components can be used. While the above describes a location system for anti theft, the same kind wireless battery or solar powered devices can be used for other applications. While the above has described very specific forms of structure and networks that can be used, other network protocols, including but not limited to Bluetooth and others can be similarly and analogously used. In addition, other applications for this system are possible and are contemplated by the present application. While the above describes the pill selector is being a robotic arm, it can alternatively be formed by other analogous structure, such as pneumatic shoots, or other known ways of moving pill bottles.)

Also, the inventors intend that only those claims which use the words “means for” are intended to be interpreted under 35 USC 112, sixth paragraph. Moreover, no limitations from the specification are intended to be read into any claims, unless those limitations are expressly included in the claims.

What is claimed is:

1. A system comprising:
a prescription dispensing system, having a plurality of individual containers therein, each individual container in a specified location, and each container having a quantity of prescription medication therein;
a container inspection device, which optically inspects the container device, and automatically determines contents within said container based on said inspection;
a selector which selects one of said containers, responsive to an external request; and sends said container to another location.

2. A system as in claim 1, further comprising a prescription verification computer, which verifies information indicative of a prescription prior to causing said selector to select said one of said containers.

3. A system as in claim 2, wherein said pill selector includes a robotic arm.

4. A system as in claim 1, wherein said inspection device reads a bar-code from said container that indicates the contents of the container.

5. A system as in claim 1, wherein said container holds pills, and said inspection device optically determines characteristics of a pill inside said pill bottle.

6. A system as in claim 2, wherein said prescription verification computer verifies at least one aspect of the prescription.

7. A system as in claim 2, wherein said prescription verification computer verifies at least one aspect of an employee who is filling the prescription before allowing the prescription to be filled.

8. A method, comprising:
storing prescription medicine in a holder in which different items of prescription medicine are automatically maintained in different locations in the holder;
automatically removing said prescription medication from areas in the holder to dispense items in the prescription medication; and
using a computer to automatically verify at least one aspect of a prescription, and only when said at least one aspect of the prescription has been verified, using the computer to automatically control said automatically removing.

9. A method as in claim 8, further comprising verifying contents of the prescription medication that is removed prior to dispensing.

10. A method as in claim 9, wherein said automatically verify comprises verifying a patient name on said prescription.

11. A method as in claim 9, wherein said prescription medication is verified using an optical sensor.

12. A method as in claim 11, wherein said optical sensor senses a bar-code on a prescription container.

13. A method as in claim 11, wherein said optical sensor verifies at least one characteristic of pills that are within a container by imaging through the container.

14. A method as in claim 9, wherein said prescription medication is automatically verified by verifying a weight of the medication.

15. A method as in claim 8, wherein said holder stores holders in a two-dimensional array.

16. A method as in claim 9, further comprising automatically verifying characteristics of an employee dispensing the pills prior to said dispensing.

17. A method as in claim 16, wherein said characteristics of the employee are verified by a biometric reader.

18. A method as in claim 16, wherein said characteristics of the employee are verified by detecting a name badge.
